(19) United States
(12) Patent Application Publication
(10) Pub. No.: US 2020/0139562 A1
(43) Pub. Date: May 7, 2020

(54) POWER TRANSMISSION SYSTEM IN MECHANICAL DEVICE

(71) Applicant: WASEDA UNIVERSITY, Tokyo (JP)

(72) Inventors: Alexander Schmitz, Tokyo (JP); Wei Wang, Tokyo (JP); Alexis Carlos Holgado, Tokyo (JP); Chincheng Hsu, Tokyo (JP); Kento Kobayashi, Tokyo (JP); Javier Alvarez Lopez, Tokyo (JP); Yushi Wang, Tokyo (JP); Shigeki Sugano, Tokyo (JP)

(73) Assignee: WASEDA UNIVERSITY, Tokyo (JP)

(21) Appl. No.: 16/495,192

(22) PCT Filed: Feb. 24, 2018
(86) PCT No.: PCT/JP2018/006834

§ 371 Date: Sep. 18, 2019

(30) Foreign Application Priority Data
Mar. 21, 2017 (JP) 2017-055173

(51) Int. Cl. B25J 19/06; B25J 9/10; B25J 9/16

(52) U.S. Cl. CPC B25J 19/068; B25J 9/1676; B25J 9/102

(57) ABSTRACT

A power transmission system 10 includes: a variable torque limiter 16 configured to allow a torque limit value to be variable, the torque limit value being an upper limit value of transmitted power from an input unit 21 to an output unit 22; an input-side displacement sensor 17A configured to detect a displacement state of the input unit 21; an output-side displacement sensor 17B configured to detect a displacement state of the output unit 22; and a control device 19 configured to perform transmission control of the power based on detection results of the respective sensors. The control device 19 includes a safety measure control function 25, a teaching control function 26, and an operation control function 27. The safety measure control function 25 interrupts transmission of the power when the transmitted power exceeds the limit value. The teaching control function 26 interrupts transmission of the power in teaching.

### TECHNICAL FIELD

The present invention relates to a power transmission system in a mechanical device that uses a variable power transmission device that allows a limit value to be variable, the limit value being an upper limit value of torque and power transmitted from input side to output side, and performs transmission control of the power to the output side under a predetermined condition.

### BACKGROUND ART

In an environment where robots and humans coexist, safety measures of the robot to the environment are important. As the safety measures, a compliance function that alleviates collision when the robot unexpectedly collides with a human or an object in an environment while the robot performs desired operation, is necessary. As the compliance function, an elastic element to absorb shock in collision, such as a spring, is commonly attached to a robot arm or the like that is a movable part of the robot. In a case where the spring is used to absorb shock, it is necessary to adjust elasticity of the spring during operation of the robot, for example, to weaken the spring to enhance cushioning property in the collision. This becomes a factor make position control of the robot arm difficult. Further, the elastic element such as the spring inhibits acceleration operation of the robot and also causes vibration during operation of the robot.

Patent Literature 1 discloses a robot including a collision torque buffer mechanism that releases force acting on an object or the like when a robot hand collides with the object or the like with external force equal to or larger than predetermined force. In the collision torque buffer mechanism, a connection portion between the robot hand side and the robot arm side is filled with lubricant, and a coupling state of the robot hand side and the robot arm side is maintained by viscosity of the lubricant even when the external force to a certain level acts on the robot arm side. On the other hand, when the external force exceeding the certain level acts on the robot arm side, relative rotation of the robot hand side and the robot arm side is allowed to buffer the force acting on the object in the collision.

In the collision torque buffer mechanism disclosed in Patent Literature 1 described above, a torque value allowing the relative rotation of the robot hand side and the robot arm side is determined based on the viscosity of the lubricant and is set to a prescribed value for each product. When considering various roles of the recent robot, however, it is desirable to provide a robot that has a variable torque value to perform various operations while securing safety. Therefore, the present inventors have already proposed a robot control system using, for example, an electromagnetic friction clutch that can electrically adjust torque transmitted from an input unit operated by a motor, to an output unit connected to a robot arm side (see Patent Literature 2).

### CITATION LIST

### Patent Literature

Patent Literature 1: Japanese Patent Laid-Open No. 2009-12088

Patent Literature 2: Japanese Patent Laid-Open No. 2017-13207

### SUMMARY OF INVENTION

### Technical Problem

To meet various needs for robot operation, other control functions are necessary in addition to the function proposed in Patent Literature 2 described above. For example, in a case where torque exceeding a preset torque limit value acts on a part between the input unit and the output unit due to occurrence of an abnormal situation, it is necessary to interrupt transmission of the torque to the output unit side to stop application of the power, from a viewpoint of safety. Further, during a teaching work in which an operator directly holds and moves the robot arm on the output unit side, thereby storing a target operation locus of the robot arm on which the robot arm is automatically moved thereafter, it is necessary to facilitate the teaching work by interrupting transmission of the torque to the output unit side to secure high back drivability on the output unit side. Moreover, in a case of using the electromagnetic friction clutch that allows the torque limit value to be variable by adjusting friction force generated between the input unit and the output unit through adjustment of an application voltage, transmission characteristics of the torque is different between when static friction force acts and when dynamic friction force acts. Therefore, to obtain the constant torque limit value, it is necessary to control the application voltage in consideration of the transmission characteristics. The control is necessary also in a case where a linear motion actuator applying pressing force, such as a driving cylinder is used as a driving device applying power to the input unit, in addition to a case where a rotary actuator such as a motor is used.

The present invention is devised in relation to the invention previously proposed, and an object of the present invention is to provide a power transmission system in a mechanical device that can achieve desired power transmission meeting various needs while securing safety for a human and an object in unexpected collision and the like.

### Solution to Problem

According to the present invention, mainly provided is a power transmission system in a mechanical device. The power transmission system transmits power from an input-side part connected to an input unit to an output-side part connected to an output unit with use of a variable power transmission device that allows a limit value to be variable, the limit value being an upper limit value of torque and power serving as transmitted power from the input unit to the output unit. The power transmission system includes: an input-side displacement sensor configured to detect a displacement state of the input unit; an output-side displacement sensor configured to detect a displacement state of the output unit; and a control device configured to perform transmission control of the power based on detection results of these sensors. The variable power transmission device enables integral operation of the input unit and the output unit to transmit the power as is when the transmitted power is equal to or lower than the limit value, and enables relative operation of the input unit and the output unit to transmit the power equal to or lower than the limit value when the transmitted power exceeds the limit value. The control device includes a safety measure control function, a teaching control function, and an operation control function. The safety measure control function interrupts transmission of the power when the transmitted power exceeds the limit value. The teaching control function interrupts transmission of the power in teaching in which the output-side part is held to manually set a target operation locus of the output-side part. The operation control function determines a target value of the transmitted power by making a calculation considering target operation and a configuration of the mechanical device, and adjusts the limit value to enable transmission of the power at the target value.

### Advantageous Effects of Invention

In the present invention, adopting the safety measure control function makes it possible to automatically detect occurrence of an abnormal situation based on the detected values of the input-side displacement sensor and the output-side displacement sensor even in a case where the abnormal situation occurs on the output unit side, for example, in a case where the output-side part collides with a human or an object around the output-side part while the power is transmitted from the input unit side to the output unit side. Further, transmission of the power from the input unit to the output unit is interrupted in response to the detection. This makes it possible to minimize occurrence of injury to the human and the object around the output-side part by the power from the input unit side when such trouble occurs.

Further, the adopted teaching control function interrupts transmission of the power from the input unit to the output unit during the teaching work in which the target operation locus is set while the output-side part is manually moved. As a result, the output unit can be freely moved, and high back drivability is applied to the output unit side to facilitate movement of the output-side part, which allows for smooth teaching. Further, it is possible to automatically return the output unit to the initial position at the start of the teaching by driving of the driving device using the detection results of the input-side displacement sensor and the output-side displacement sensor, irrespective of the position of the output unit at the end of the teaching. In other words, even when transmission of the power between the input unit and the output unit is temporarily interrupted in order to facilitate movement of the output-side part in the teaching, it is possible to allow transmission of the power and to surely return the output unit to the initial position with use of the power of the driving device on the input unit side based on the detection results of the respective displacement sensors, at the end of the teaching. Accordingly, it is possible to surely reflect the movement of the output-side part set in the teaching when the output-side part is automatically operated after the teaching, without mismatching of the initial position of the output unit between at the start and at the end of the teaching.

Further, in the case where the electromagnetic friction clutch is used as the variable power transmission device, the friction force interposed between the input unit and the output unit is changed from the maximum value of the static friction force to the dynamic friction force and the limit value is reduced before and after the relative movement of the input unit and the output unit. In the operation control function, the voltage of a first voltage value at which the target transmitted power is matched to the maximum static friction force is first applied. Further, after the timing at which the friction force is changed from the static friction force to the dynamic friction force is automatically detected from the detection results of the input-side displacement sensor and the output-side displacement sensor, the voltage of a second voltage value that is larger than the first voltage value and at which the target transmitted power is matched to the dynamic friction force, becomes applicable. This makes it possible to secure the limit value that is constant at all times in consideration of the kind of friction force, even before and after the relative movement of the input unit and the output unit.

According to the above-described present invention, it is possible to secure safety at the time of unexpected collision to a human and an object, and the like. In addition, it is possible to surely reproduce the movement in the teaching work with small force. Moreover, it is possible to surely transmit the power at the desired target value from the input unit to the output unit while securing safety.

### BRIEF DESCRIPTION OF DRAWINGS

FIG. 1 is a schematic configuration diagram of a power transmission system according to an embodiment.

FIG. 2 is a schematic configuration diagram similar to FIG. 1 according to a modification.

### DESCRIPTION OF EMBODIMENT

An embodiment of the present invention is described below with reference to drawings.

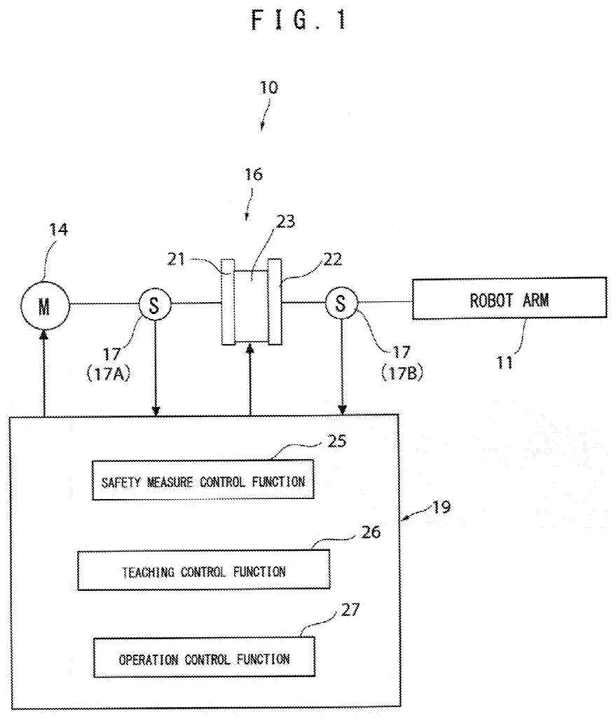

FIG. 1 is a schematic configuration diagram of a power transmission system in a mechanical device according to the present embodiment. In the figure, a power transmission system 10 includes a robot arm 11, a motor 14, a variable torque limiter 16, displacement sensors 17, and a control device 19. The robot arm 11 is provided so as to be movable in a predetermined space and performs a predetermined work in the space. The motor 14 serves as a driving device applying torque as power to the robot arm 11. The variable torque limiter 16 serves as a variable power transmission device that is disposed between the robot arm 11 and the motor 14 and variably transmits transmission torque as transmitted power from the motor 14 to the robot arm 11. The displacement sensors 17 detects displacement states of input side and output side of the variable torque limiter 16. The control device 19 controls transmission from the input side to the output side based on detection results of the displacement sensors 17. Although not particularly limited, the members and devices other than the robot arm 11 are provided near the robot arm 11, for example, at a joint part.

The robot arm 11 includes a well-known power transmission mechanism that allows for movement in the predetermined space while rotationally moving the joint part, by the power of the motor 14. A detailed configuration of the robot arm 11 is not essence of the present invention. Therefore, illustration and detailed description of the configuration are omitted. Note that, as the robot arm 11, a configuration in which an object held by a holding unit (held object) can be moved in a predetermined space through previously instructed operation by a cantilevered articulated configuration including the holding unit at a front end, can be exemplified.

In the present embodiment, the variable torque limiter 16 is not particularly limited but is configured by a well-known electromagnetic friction clutch. The variable torque limiter 16 is provided such that a limit value (hereinafter, referred to as “torque limit value”) as an upper limit of the torque transmitted from the motor 14 side to the robot arm 11 side is variable through adjustment of an application voltage. Relationship between a value of the application voltage and the torque limit value is previously stored in the control device 19, and the control device 19 controls the torque limit value described below through adjustment of the application voltage.

The variable torque limiter 16 includes an input unit 21, an output unit 22, and a transmission unit 23. The input unit 21 is connected to the motor 14 side as an input-side part and is provided so as to be rotatable by driving of the motor 14. The output unit 22 is connected to the robot arm 11 side as an output-side part and is rotatably provided. The transmission unit 23 is disposed between the input unit 21 and the output unit 22, and can transmit the torque from the input unit 21 to the output unit 22 with use of friction force.

In the variable torque limiter 16, when input torque by rotation of the input unit 21 is equal to or lower than the torque limit value controlled by the control device 19, the input unit 21 and the output unit 22 are integrally rotated to transmit the input torque as is to the output unit 22. In contrast, when the input torque exceeds the torque limit value, slip operation allowing relative rotation of the input unit 21 and the output unit 22 occurs to transmit the torque equal to or lower than the torque limit value, to the output unit 22.

Note that, as the variable torque limiter 16, for example, a magnetic fluid clutch in which the transmission unit 23 is configured by magnetic fluid and viscosity of the magnetic fluid is electrically adjusted can be adopted, in addition to the electromagnetic friction clutch. In other words, other variable power transmission devices such as various clutches, torque limiters, and brakes can be adopted as long as the transmission torque from the input unit 21 to the output unit 22 is adjustable as described above.

The displacement sensors 17 are not particularly limited as long as the displacement sensors 17 can detect information for control by the control device 19 described below. In the present embodiment, encoders provided on the input side and the output side of the variable torque limiter 16 are used as the displacement sensors 17. An input-side encoder 17A (input-side displacement sensor) disposed on the input side of the variable torque limiter 16 detects a displacement amount of a rotation angle of the input unit 21. In contrast, an output-side encoder 17B (output-side displacement sensor) disposed on the output side of the variable torque limiter 16 detects a displacement amount of a rotation angle of the output unit 22. Detected values of the respective encoders 17A and 17B are sequentially transmitted to the control device 19 every predetermined time.

The control device 19 is configured by a computer including an arithmetic processing unit such as a CPU and a storage device such as a memory and a hard disk. The control device 19 performs driving control of the motor 14 and operation control of the variable torque limiter 16 through adjustment of the application voltage, based on each of control modes described below.

More specifically, the control device 19 includes a safety measure control function 25, a teaching control function 26, and an operation control function 27. The safety measure control function 25 performs control in a safety measure control mode for safety measures when the transmission torque from the input unit 21 to the output unit 22 exceeds the torque limit value. The teaching control function 26 performs control in a teaching control mode when teaching in which the robot arm 11 is held to manually set a target operation locus is performed. The operation control function 27 performs control in an operation control mode in which the robot arm 11 is operated with a desired torque limit value. These functions 25 to 27 are executed in the following manner in response to selection of any of the control modes; however, the control device 19 may be configured to include only at least one of these functions 25 to 27.

The safety measure control function 25 performs transmission control in the following safety measure control mode through operation control of the variable torque limiter 16.

In this case, difference between the detected value of the input-side encoder 17A and the detected value of the output-side encoder 17B is calculated. In a case where the difference exceeds a preset value, it is determined that the slip operation has occurred between the input unit 21 and the output unit 22, and no or weak application voltage is supplied to the variable torque limiter 16 such that the torque limit value becomes substantially zero or a minimum value not causing a fall of the robot arm 11 in order to interrupt transmission of the torque by the variable torque limiter 16.

According to the safety measure control mode, in a case where any trouble occurs between the input unit 21 and the output unit 22, for example, in a case where the robot arm 11 on the output side collides with a human or an object around the robot arm 11 and external force accordingly acts on the robot arm 11, the trouble is automatically detected from generation of the difference between the displacement angle detected by the input-side encoder 17A and the displacement angle detected by the output-side encoder 17B, and transmission of the torque between the input unit 21 and the output unit 22 is interrupted through operation control of the variable torque limiter 16. Accordingly, when such an abnormal situation occurs, the robot arm 11 is separated from driving of the motor 14 to minimize influence of the robot arm 11 on the human and the object by transmission of the power of the motor 14. This makes it possible to take safety measures necessary for coexistence of robots and humans.

The teaching control function 26 performs transmission control in the following teaching control mode through driving control of the motor 14 and operation control of the variable torque limiter 16.

When the transmission control in the teaching control mode is selected with respect to the control device 19 by an unillustrated operator or the like at the start of the teaching work, the application voltage to the variable torque limiter 16 is adjusted so as to interrupt transmission of the torque by the variable torque limiter 16, as with the above-described safety measure control mode. Thereafter, the robot arm 11 is moved along a desired target operation locus while being held by a hand of the operator or the like, and the displacement angle detected by the output-side encoder 17B is stored with time. When the teaching ends and a switch or the like (not illustrated) to start automatic operation of the robot arm 11 is turned on by the operator or the like, transmission of the torque by the variable torque limiter 16 is allowed. In addition, the robot arm 11 is automatically returned to an initial position at the start of the teaching by driving of the motor 14, and then, the robot arm 11 automatically performs repetitive operation along the target operation locus designated by the teaching.

In other words, in the teaching control function 26, when the teaching is started, transmission of the torque is interrupted. In contrast, when the teaching ends, the variable torque limiter 16 is operated so as to enable transmission of the torque. Further, after the teaching, automatic return control to automatically return the robot arm 11 to the initial position is performed by driving of the motor 14. The automatic return control is described in detail below.

In the teaching work, transmission of the torque between the input unit 21 and the output unit 22 is interrupted. Therefore, an angle position of the output unit 22 at the start of the teaching work is regarded as the initial position, and when the initial position is set as a start position of the automatic operation of the robot arm 11 after the teaching, it is necessary to move the robot arm 11 such that the position of the output unit 22 accurately coincides with the initial position after the teaching. Although it is difficult to make the position accurately coincide with the initial position by manual operation, it is possible to surely return the output unit 22 to the initial position by the automatic return control.

More specifically, in the automatic return control, a detected value a₀ of the input-side encoder 17A and a detected value b₀ of the output-side encoder 17B at the start of the teaching are first stored. Note that a detected value bₜ of the output-side encoder 17B is stored every predetermined time t along with the teaching, and the detected value bₜ is used for control of automatic operation after the teaching. Further, a detected value aₙ of the input-side encoder 17A and a detected value bₙ of the output-side encoder 17B at the end of the teaching are stored. At the end of the teaching, the torque can be transmitted between the input unit 21 and the output unit 22 as described above. Therefore, difference Δb between the detected value b₀ of the output-side encoder 17B at the start of the teaching and the detected value bₙ of the output-side encoder 17B at the end of the teaching is calculated, and the input unit 21 is rotated, by driving of the motor 14, by an angle corresponding to the difference Δb with respect to the detected value aₙ that is a rotation position of the input unit 21 at the end of the teaching. As a result, the output unit 22 interlocking with the input unit 21 is rotated by the angle corresponding to the difference Δb so as to be returned to the initial angle (initial position) at the start of the teaching, which automatically returns the robot arm 11 to the start position.

Therefore, according to the teaching control mode, in the teaching performed by human hands, the input unit 21 on the motor 14 side and the output unit 22 on the robot arm 11 side are decoupled by the variable torque limiter 16, which allows for smooth movement of the robot arm 11 with light force irrespective of the driving state of the motor 14. Further, although the robot arm 11 side is disconnected from the motor 14 in the teaching, the output unit 22 can be automatically returned to the initial position with use of the detected values of the input-side encoder 17A and the detection results of the output-side encoder 17B before and after the start of the teaching. Accordingly, it is possible to accurately return the robot arm 11 to the start position at the start of the teaching by driving of the motor 14, irrespective of the position of the robot arm 11 at the end of the teaching. As a result, the robot arm 11 can be automatically operated in a state where the target operation locus is surely reflected, without deviation between the target operation locus set in the teaching and the operation locus in the actual automatic operation.

The operation control function 27 performs transmission control in the following operation control mode through driving control of the motor 14 and operation control of the variable torque limiter 16.

The operation control function 27 determines target torque that is a target value of the torque transmitted from the input unit 21 to the output unit 22 by making a calculation considering the target operation and the configuration of the robot arm 11, and adjusts the torque limit value so as to enable transmission of the power at the target torque. In other words, to specify the target position of the robot arm 11 with time corresponding to the target operation of the robot arm 11 set by the above-described teaching and the like, target rotation values (target rotation angle, target rotation speed, and target rotation acceleration) of joint parts of the robot arm 11 to time are determined. Further, the target torque is determined by making a calculation of a well-known numerical expression with use of the target rotation value and current position information of the robot arm 11, known inertia tensor of the robot arm 11 and the like, and a vector of Coriolis force and a vector of centripetal force determined based on the current position information, while the rotation angle from the output-side encoder 17B corresponding to the current position information of the robot arm 11 is fed back. Further, to obtain the target torque, driving control of the motor 14 is performed and the torque limit value is adjusted through operation control of the variable torque limiter 16. In this case, torque equal to or slightly larger than the target torque is set as the torque limit value, and the application voltage to the variable torque limiter 16 is determined so as to allow the relative rotation of the output unit 22 to the input unit 21 and to cause slip operation of the variable torque limiter 16 when the torque exceeding the torque limit value acts on the variable torque limiter 16.

In the present embodiment, since the electromagnetic friction clutch is used as the variable torque limiter 16, the operation control function 27 preferably performs control to adjust the application voltage in consideration of influence of static friction force and dynamic friction force at the transmission unit 23 interposed between the input unit 21 and the output unit 22. In the following, specific description including the reason therefor is given.

In the case where the torque equal to or lower than the torque limit value acts on the variable torque limiter 16, the input unit 21 and the output unit 22 are coupled and integrally rotated. In this state, the integral rotation is performed by the static friction force at the transmission unit 23. In contrast, in the case where the torque exceeding the torque limit value acts on the variable torque limiter 16, slip operation in which the input unit 21 and the output unit 22 are relatively rotated occurs. At this time, the torque equal to or lower than the torque limit value is transmittable by action of the dynamic friction force on the transmission unit 23. Further, at the time when the slip operation is started, the friction force at the maximum level (hereinafter, referred to as “maximum friction force”) acts.

When the voltage is applied to the variable torque limiter 16 in order to obtain the torque limit value set corresponding to the target torque (hereinafter, referred to as “target limit value”), the following issues occur due to the characteristics of the electromagnetic friction clutch described above.

In a case where the application voltage to the variable torque limiter 16 is set to a constant first voltage value at which the target limit value corresponding to the maximum friction force is obtainable in consideration of the static friction force, the torque limit value is reduced by influence of the dynamic friction force lower than the maximum friction force after the input unit 21 and the output unit 22 are relatively rotated. Accordingly, if the input unit 21 and the output unit 22 are relatively rotated, the desired target limit value is not obtainable. Even when the subsequent torque from the input unit 21 is equal to or lower than the desired target limit value, the integral rotation of the input unit 21 and the output unit 22 is not compensated in some cases.

On the other hand, in a case where the application voltage to the variable torque limiter 16 is set to a second voltage value at which the target limit value corresponding to influence of the dynamic friction force during the slip operation is obtainable, namely, set to a constant voltage value larger than the first voltage value, the limit value at the maximum friction force is increased, which may inhibit achievement of the desired safety measures and the like.

Therefore, in the operation control function 27, in a case where the difference between the detected value of the input-side encoder 17A and the detected value of the output-side encoder 17B exceeds the preset value, occurrence of the slip operation is first detected, as with the safety measure control mode. Thereafter, the magnitude of the application voltage is changed in response to detection of occurrence of the slip operation. In other words, the application voltage to the variable torque limiter 16 is controlled such that, when the input unit 21 and the output unit 22 are integrally rotated, the application voltage is set to the first voltage value considering the static friction force, and when occurrence of the slip operation is detected, the application voltage is increased to the second voltage value considering the dynamic friction force.

According to the aspect, it is possible to maintain the desired constant torque limit value irrespective of the state of the friction force acting on the transmission unit 23, and to avoid unintended slip operation and unintended torque transmission. This makes it possible to take more secure safety measures.

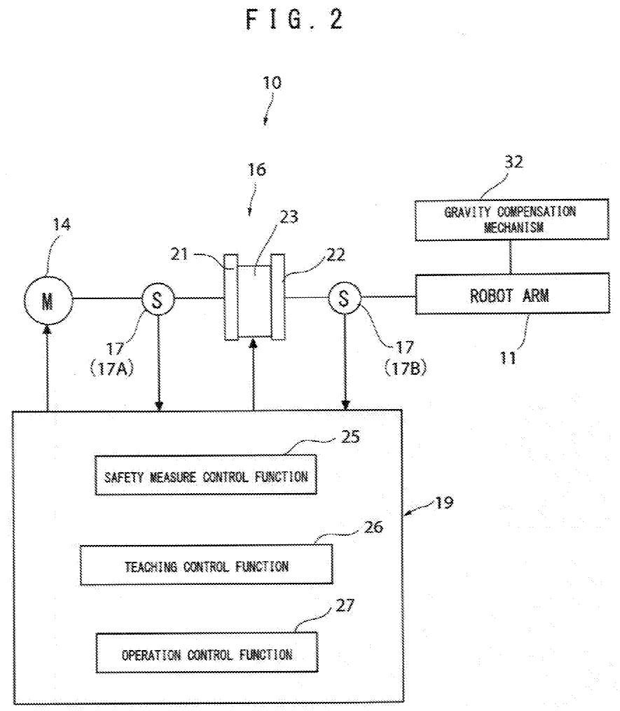

Note that, as illustrated in FIG. 2, a gravity compensation mechanism 32 that cancels influence of the gravity by the robot arm 11 with respect to the power transmission system 10 according to the embodiment, may be further provided on the robot arm 11.

The gravity compensation mechanism 32 includes a well-known mechanism that can perform adjustment so as to cancel influence on the gravity by the entire robot arm 11 including the dead weight of the robot arm 11 and the weight of the held object. Examples of the well-known mechanism include a spring balance-type gravity compensation mechanism including a link structure using a spring. In a case of performing the dead weight compensation including the weight of the held object, an adjustable dead-weight compensation mechanism in which tension of the spring is dynamically adjustable based on the weight of the held object can be adopted as the gravity compensation mechanism 32, in addition to the mechanism in which the tension of the spring is previously adjusted to compensate the dead weight of only the robot arm 11. Furthermore, the gravity compensation mechanism 32 that has any of various configurations having the same action, such as a counter-weight type, can be adopted.

Adopting the gravity compensation mechanism 32 makes it possible to omit a gravity term in calculation of the target torque in the above-described operation control mode, which allows for the calculation with extreme ease. Further, when the torque limit value is set to the minimum value to interrupt the transmission of the torque from the motor 14 side to the robot arm 11 side in each of the safety measure control mode and the teaching control mode, it is possible to prevent a fall of the robot arm 11 due to the dead weight and to move the robot arm 11 with small force in the teaching. Moreover, since it is unnecessary to apply resistance force to prevent a fall of the robot arm 11 due to the dead weight when the transmission of the torque is interrupted, the minimum value of the torque limit value can be as small as possible, when the transmission of the torque is interrupted, and may be zero. As a result, the motor 14 and the variable torque limiter 16 that are disposed at many positions in the robot can be downsized, and it is possible to promote weight reduction of the entire robot arm 11 even when the gravity compensation mechanism 32 is provided.

The power transmission system 10 according to the embodiment is suitable for the robot arm 11; however, application of the present invention is not limited thereto, and the power transmission system 10 is applicable to the other mechanical devices. For example, the power transmission system 10 is applicable to a reinforcing exoskeleton device in which the power supply from the input-side part is not performed by the driving device such as a motor 14 but the power supply from the input side is manually performed with simultaneous use of the gravity compensation mechanism 32. The reinforcing exoskeleton device is disposed along joints of a human for power assist. Simultaneously using the gravity compensation mechanism 32 makes it possible to perform power assist without using the driving device, which allows for enhancement of energy efficiency.

Further, in the embodiment, the motor 14 that is a rotary actuator is used as the driving device to perform power supply on the input side; however, the driving device in the present invention is not limited thereto, and a linear motion actuator such as a cylinder can be used as the driving device in addition to the other rotary actuators. The above-described torque in this case becomes translational force such as pressing force.

Other than the above, the configurations of the units in the device according to the present invention are not limited to the illustrated configuration examples, and can be variously modified in so far as a modification has substantially similar action.

### REFERENCE SIGNS LIST

10 Power transmission system
11 Robot arm (output-side part)
14 Motor (input-side part)
16 Variable torque limiter (variable operation device)
17A Input-side encoder (input-side displacement sensor)
17B Output-side encoder (output-side displacement sensor)
19 Control device
25 Safety measure control function
26 Teaching control function
27 Operation control function
32 Gravity compensation mechanism

1. A power transmission system in a mechanical device, the power transmission system transmitting power from an input-side part connected to an input unit to an output-side part connected to an output unit with use of a variable power transmission device that allows a limit value to be variable, the limit value being an upper limit value of torque and power serving as transmitted power from the input unit to the output unit, the power transmission system including:
an input-side displacement sensor configured to detect a displacement state of the input unit;
an output-side displacement sensor configured to detect a displacement state of the output unit; and
a control device configured to perform transmission control of the power based on detection results of these sensors, wherein
the variable power transmission device enables integral operation of the input unit and the output unit to transmit the power as is when the transmitted power is equal to or lower than the limit value, and enables relative operation of the input unit and the output unit to transmit the power equal to or lower than the limit value when the transmitted power exceeds the limit value, and
the control device includes a safety measure control function, a teaching control function, and an operation control function, the safety measure control function being operable to interrupt transmission of the power when the transmitted power exceeds the limit value, the teaching control function being operable to interrupt transmission of the power in teaching in which the output-side part is held to manually set a target operation locus of the output-side part, and the operation control function being operable to determine a target value of the transmitted power by making a calculation considering target operation and a configuration of the mechanical device and to adjust the limit value to enable transmission of the power at the target value.

2. The power transmission system in the mechanical device according to claim 1, wherein the safety measure control function operates the variable power transmission device to interrupt transmission of the power when difference between a detected value of the input-side displacement sensor and a detected value of the output-side displacement sensor is larger than a preset value.

3. The power transmission system in the mechanical device according to claim 1, further including a driving device configured to apply the power to the input unit, wherein
the teaching control function operates the variable transmission device to interrupt transmission of the power at the start of the teaching and to enable transmission of the power at the end of the teaching, calculates difference between detected values of the output-side displacement sensor at the start of the teaching and at the end of the teaching, and returns the output unit to an initial position at the start of the teaching with use of power from the input unit by causing displacement corresponding to the difference with respect to the detected value of the input-side displacement sensor through driving of the driving device.

4. The power transmission system in the mechanical device according to claim 1, wherein
the variable power transmission device includes an electromagnetic friction clutch that transmits the power with use of static friction force generated between the input unit and the output unit when the transmitted power is equal to or lower than the limit value whereas transmits the power with use of dynamic friction force generated between the input unit and the output unit when the transmitted power exceeds the limit value, and adjusts the static friction force and the dynamic friction force based on a magnitude of an application voltage, and
the operation control function maintains the limit value at a predetermined value by changing the application voltage between a case where difference between a detected value of the input-side displacement sensor and a detected value of the output-side displacement sensor is larger than a preset value and a case where the difference is not larger than the preset value.

5. The power transmission system in the mechanical device according to claim 1, wherein the output-side part is provided with a gravity compensation mechanism that cancels influence of gravity on the output-side part.

6. A power transmission system in a mechanical device, the power transmission system transmitting power from an input-side part connected to an input unit to an output-side part connected to an output unit with use of a variable power transmission device that allows a limit value to be variable, the limit value being an upper limit value of torque and power serving as transmitted power from the input unit to the output unit, the power transmission system including:
an input-side displacement sensor configured to detect a displacement state of the input unit;
an output-side displacement sensor configured to detect a displacement state of the output unit; and
a control device configured to control operation of the variable power transmission device based on detection results of these sensors, wherein
the variable power transmission device enables integral operation of the input unit and the output unit to transmit the power as is when the transmitted power is equal to or lower than the limit value, and enables relative operation of the input unit and the output unit to transmit the power equal to or lower than the limit value when the transmitted power exceeds the limit value, and
the control device includes a safety measure control function for safety measures when the transmitted power exceeds the limit value, and
the safety measure control function operates the variable power transmission device to interrupt transmission of the power from the input unit to the output unit when difference between a detected value of the input-side displacement sensor and a detected value of the output-side displacement sensor is larger than a preset value.

7. A power transmission system in a mechanical device, the power transmission system transmitting power from an input-side part connected to an input unit to an output-side part connected to an output unit with use of a variable power transmission device that allows a limit value to be variable, the limit value being an upper limit value of torque and power serving as transmitted power from the input unit to the output unit, the power transmission system including:
a driving device configured to apply the power to the input unit;
an input-side displacement sensor configured to detect a displacement state of the input unit;
an output-side displacement sensor configured to detect a displacement state of the output unit; and
a control device configured to control driving of the driving device and operation of the variable power transmission device, wherein
the control device includes a teaching control function in teaching in which the output-side part is held to manually set a target operation locus of the output-side part, and
the teaching control function operates the variable transmission device to interrupt transmission of the power at start of the teaching and to enable transmission of the power at end of the teaching, calculates difference between detected values of the output-side displacement sensor at the start of the teaching and at the end of the teaching, and returns the output unit to an initial position at the start of the teaching with use of power from the input unit by causing displacement corresponding to the difference with respect to the detected value of the input-side displacement sensor through driving of the driving device.

8. A power transmission system in a mechanical device, the power transmission system transmitting power from an input-side part connected to an input unit to an output-side part connected to an output unit with use of a variable power transmission device that allows a limit value to be variable, the limit value being an upper limit value of torque and power serving as transmitted power from the input unit to the output unit, the power transmission system including:
an input-side displacement sensor configured to detect a displacement state of the input unit;
an output-side displacement sensor configured to detect a displacement state of the output unit; and
a control device configured to control operation of the variable power transmission device, wherein
the variable power transmission device includes an electromagnetic friction clutch that enables integral operation of the input unit and the output unit to transmit the power as is with use of static friction force generated between the input unit and the output unit when the transmitted power is equal to or lower than the limit value whereas it enables relative operation of the input unit and the output unit to transmit the power equal to or lower than the limit value with use of dynamic friction force generated between the input unit and the output unit when the transmitted power exceeds the limit value, and adjusts the friction forces based on a magnitude of an application voltage,
the control device includes an operation control function that determines a target value of the transmitted power by making a calculation considering target operation and a configuration of the mechanical device and adjusts the limit value to enable transmission of the power at the target value, and
the operation control function maintains the limit value at a predetermined value by changing the application voltage between a case where difference between a detected value of the input-side displacement sensor and a detected value of the output-side displacement sensor is larger than a preset value and a case where the difference is not larger than the preset value.
